(19) United States
(12) Patent Application Publication
(10) Pub. No.: US 2007/0294430 A1
(43) Pub. Date: Dec. 20, 2007

(54) Generating a device address persistent across different instantiations of an electronic device

(75) Inventors: Kaushik R. Narayanan, Redmond, WA (US); Robert J. Martin, Bellevue, WA (US); Santosh S. Jodh, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/471,211

(22) Filed: Jun. 20, 2006

(51) Int. Cl. G06F 15/16

(52) U.S. Cl. 709/245

(57) ABSTRACT

Generating a device address persistent across different instantiations of an electronic device at a computer system. A device identifier identifying the electronic device is received from the electronic device communicatively coupled to the computer system at a interface. An interface identifier identifying the interface is received. A persistent device identifier based on the device identifier and the interface identifier is generated. The persistent device identifier statically defines the electronic device at the interface across different instantiations of the electronic device at the computer system.

### BACKGROUND

In general, before a product—hardware or software—is brought to market, it may be tested in different ways, to demonstrate its workability or to determine whether it is compatible with other products, for example. In the computer industry, for example, a prototypical consumer electronic device may be tested by repeatedly plugging it into and unplugging it from a computer system under various operating conditions. That is, the device may be “hot swapped” into and out of the computer system with the computer in different power states (e.g., full power, sleeping or hibernating, standby) and also with the computer turned off. Testing of this sort may be performed hundreds or thousands of times per device.

Currently, consumer electronic devices that connect to computers are assigned a handle during operation, also referred to as a device instance identifier (ID). In testing device drivers or hardware devices not having unique serial numbers, changes during certain tests, such as hot swapping tests or power management tests, can cause the device instance ID for a device to change. These changes in device instance ID must be actively monitored and are not automatically detected. Accordingly, testing of drivers and devices must be performed manually.

The nature of the testing can be time-consuming, which can increase costs. These problems are magnified when it is necessary or desirable to test a number of devices in parallel. Different combinations of the devices may need to be tested, each combination at different power conditions. Not only can this increase the cost and duration of the testing, but managing and implementing such a variety of tests can be unduly complex.

A solution to the problems mentioned above would thus be advantageous.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A persistent device identifier statically defining an electronic device across different instantiations of the electronic device at a computer system is provided. A device identifier identifying the electronic device is received from the electronic device communicatively coupled to the computer system at a interface. An interface identifier identifying the interface is received. The persistent device identifier is generated based on the device identifier and the interface identifier.

### DESCRIPTION OF THE DRAWINGS

The accompanying drawings, which are incorporated in and form a part of this specification, illustrate embodiments of the technology and, together with the description, serve to explain the principles of the technology:

FIG. 1 is a block diagram of an exemplary computer system upon which embodiments of the technology may be implemented.

FIG. 2 is a block diagram of an operating environment in accordance with one embodiment of the technology.

FIG. 3 is a block diagram showing an example of a data structure according to an embodiment of the present technology.

FIG. 4 is a flowchart of a method for addressing an electronic device in accordance with one embodiment of the technology.

The drawings referred to in this description should not be understood as being drawn to scale except if specifically noted.

### DETAILED DESCRIPTION

Reference will now be made in detail to various embodiments, examples of which are illustrated in the accompanying drawings. While the subject matter defined in the appended claims is described in conjunction with these embodiments, it is to be understood that the subject matter of the appended claims is not limited to these embodiments. On the contrary, these embodiments are intended to cover alternatives, modifications and equivalents that may be included within the spirit and scope of the subject matter of the appended claims. Furthermore, in the following description, numerous specific details are set forth in order to provide a thorough understanding, while in other instances, well-known methods, procedures, components, and circuits have not been described in detail so as not to unnecessarily obscure aspects of the present technology.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, terms such as “addressing,” “receiving,” “generating,” “defining,” “detecting,” “identifying” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

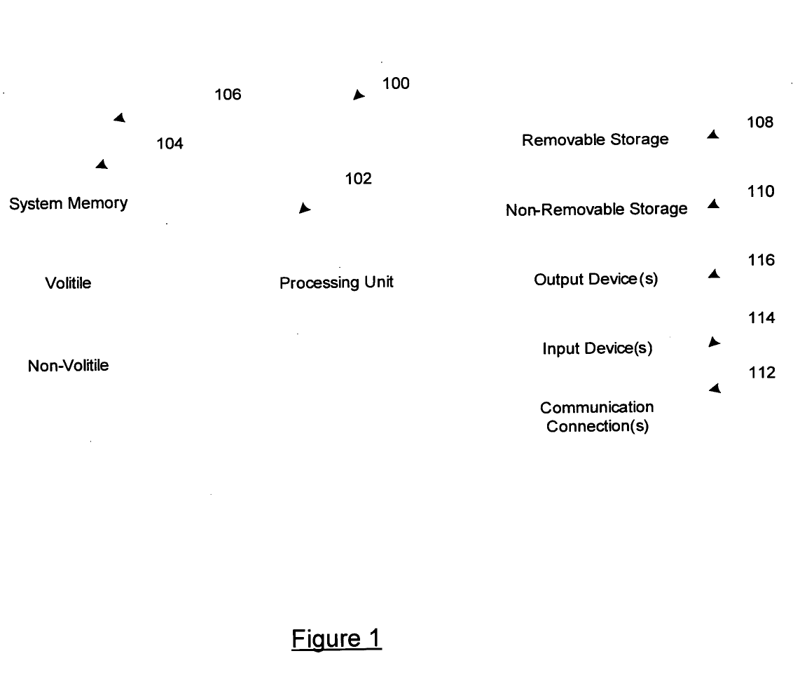

With reference to FIG. 1, an exemplary system for implementing the technology includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. For purposes of the present application, communications connection(s) 112 may be referred to herein as interfaces.

Device 100 may also have input device(s) 114 such as keyboard, mouse, pen, voice input device, touch input device, etc. Output device(s) 116 such as a display, speakers, printer, etc. may also be included. The operations of these devices are well known in the art and need not be discussed at length here. It should be appreciated that input device 114 and output devices 116 are communicatively coupled to device 100 at interfaces, also referred to as communication ports.

In one embodiment, device 100 runs an operating system which supports multiple applications. One such operating system is a Windows® brand operating system sold by Microsoft Corporation, such as Windows® 95, Windows® NT, Windows® XP or other derivative versions of Windows®. It is noted, however, that other operating systems may be employed, such as the Macintosh operating system from Apple Computer, Inc. and the OS/2 operating system from IBM.

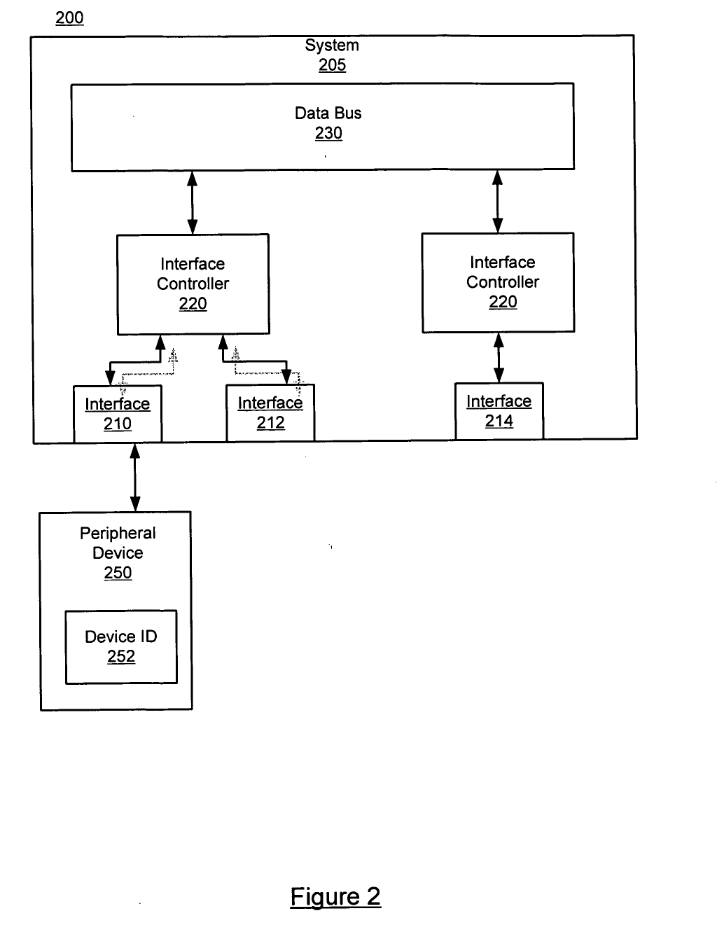

FIG. 2 illustrates an example of a suitable operating environment 200 in which the technology may be implemented. The operating environment 200 is only one example of a suitable operating environment and is not intended to suggest any limitation as to the scope of use or functionality of the technology. Other well known computing systems, environments, and/or configurations that may be suitable for use with the technology include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

Operating environment 200 includes a computing device 205 that may be communicatively coupled to an electronic device, e.g., peripheral device 250. In one embodiment, computing device 205 includes the components of computing device 100 of FIG. 1.

Computing device 205 includes a data bus 230, interface controllers 220 and 222, and interfaces 210, 212 and 214. It should be appreciated that there may be any number of interfaces, also referred to as communication ports. For example, the number of interfaces included may depend on, for example, the capabilities (e.g., the processing power and memory capacity) of processing unit 102 of FIG. 1. Similarly, computing device may include any number of interface controllers. The number of interfaces and interface controllers is not meant to be limited by the illustrated embodiment.

Data bus 230 is communicatively coupled to interfaces 210, 212 and 214. In one embodiment, data bus 230 is assigned an instance identifier (ID). In one embodiment, the instance ID is a computer system-defined identification string. In one embodiment, the instance ID for data bus 230 is accessible by computing system 205 by requesting the instance ID for data bus 230. For example, in a Windows® brand operating system, an instance ID is obtained by using an IRP_MN_QUERY_ID request and setting the Parameters.QueryId.IdType field to BusQueryInstanceID. The instance ID is persistent across different instantiations of computing system 205, e.g., across system boots. It should be appreciated that data bus 230 may be implemented as any type of bus for transmitting data, including but not limited to a Human Interface Device (HID) bus, a Peripheral Component Interconnect (PCI) bus, a Small Computer System Interface (SCSI) bus, an Integrated Drive Electronics (IDE) bus, and the like.

The interfaces 210, 212 and 214 are used to communicatively link device 205 with other electronic devices, e.g., peripheral device 250. These other devices may include a computer system as well as other types of devices, referred to herein as peripheral devices. Peripheral devices can include the types of devices that may be connected to a computer system, such as, but not limited to, printers, scanners, keyboards, mice, cameras and memory devices (e.g., memory capacity devices such as hard drives, or portable memory devices such as removable flash memory cards). Peripheral devices can also include devices that are connected to a computer system but may be internal to the computer system housing, such as, but not limited to, PCMCIA (Personal Computer Memory Card International Association) cards, video cards and sound cards.

In one embodiment, these peripheral devices do not have a unique serial number or other unique identifier that uniquely identifies the peripheral device from all other peripheral devices. For instance, certain peripheral devices may include a unique identifier, such as a network interface card (NIC) including a unique Media Access Control (MAC) address. This MAC address is unique to the NIC, such that a computing device may always identify the NIC by the MAC address.

However, some peripheral devices do not include such unique identifiers. For example, a mouse or a keyboard may not be identified with a unique serial number. In one embodiment, the peripheral device includes a device identifier (ID), e.g., device ID 252 of FIG. 2. The device ID includes information identifying the peripheral device such that different types of devices and/or having different vendors will have different device IDs. In one embodiment, the device ID is a vendor-defined identification string. In one embodiment, the device ID includes a product number, also referred to as a product identifier, and a vendor number, also referred to as a vendor identifier. For example, all type ABC mouse devices supplied by vendor XYZ will include the same device ID, and will be individually indistinguishable from each other. However, the ABC mouse devices will be distinguishable from all other mouse devices, either by vendor XYZ or by other vendors.

In one embodiment, the device ID is stored in a memory device of the associated peripheral device. For example, the device ID may be stored within any type of storage media, including but not limited to, RAM, ROM, EEPROM, flash memory or other memory technology.

In one embodiment, device ID is a vendor-defined identification string that allows computing device 205 to match the peripheral device to installation information file, e.g., an INF file in a Windows® brand operating system. In one embodiment, the device ID for a peripheral device is accessible by computing system 205 by requesting the device ID from the peripheral device. For example, in a Windows® brand operating system, a device ID is obtained by using an IRP_MN_QUERY_ID request and setting the Parameters.QueryId.IdType field to BusQueryDeviceID. The device ID is persistent across different instantiations of computing system 205, e.g., across system boots, unplugging and plugging the device, and the like.

Interfaces 210, 212 and 214 may be implemented as different types of communication interfaces. Examples of communication interfaces that can be utilized with device 205 include, but are not limited to, universal serial bus (USB), IEEE-1394 (referred to as Firewire), peripheral component interface (PCI), human interface device (HID) (e.g., keyboard), intelligent drive electronics or integrated drive electronics (IDE), small computer system interface (SCSI), serial, Ethernet, and generic.

In the illustrated embodiment, interfaces 210 and 212 are communicatively coupled to interface controller 220 and interface 214 is communicatively coupled to interface controller 222. It should be appreciated that other components may be located between the interface controllers and the interfaces, such as hub devices.

In one embodiment, each interface is uniquely identified within computing device 205 by an interface identifier (ID). In one embodiment, the interface identifier includes a device address of the interface and the instance ID for data bus 230. In one embodiment, the interface identifier also includes the device address of the peripheral device, e.g., peripheral device 250. In one embodiment, the device address of the interface includes a hierarchical chain device address between bus 230 and the peripheral device. For example, in a Windows® brand operating system, the hierarchical chain device address is extracted from a sub tree in a device manager configuration. The hierarchical chain device address is persistent across different instantiations of computing system 205.

Computing system 205 is operable to generate a persistent device identifier for a peripheral device communicatively coupled to a particular interface based on the device ID for the peripheral device and the interface identifier for the interface. The persistent device identifier uniquely defines a peripheral device across different instantiations of the peripheral device at the computing system 205. Instantiations refer to instances of a peripheral device being recognized by computing system 205. For example, unplugging and re-plugging of the peripheral device at the computing system causes the termination of a first instantiation and the initiation of a second instantiation. Furthermore, different instantiations may be caused by rebooting computing system 205, removing power to computing system 205, removing power to the peripheral device, uninstalling and reinstalling the peripheral device, uninstalling and reinstalling the interface controller for the interface communicatively coupled to the peripheral device, and other types of power management tests. In general, an instantiation refers to the computing system recognizing the peripheral device.

The persistent device identifier for the peripheral device statically defines the peripheral device across different instantiations of the peripheral device at a particular interface. For example, computing system 205 is operable to generate a persistent device identifier for peripheral device 250 at interface 210. Each instantiation of peripheral device 250 at interface 210 will result in the generation of the same persistent device identifier. However, if peripheral device 250 is communicatively coupled to another interface, e.g., interface 212, a different persistent device identifier will be generated for instantiations of peripheral device 250 at interface 212.

In one embodiment, the persistent device identifier generation and maintenance is operating system dependent. For example, in a Windows® brand operating system, the persistent device identifier is maintained in a device manager. In one embodiment, the persistent device identifier is generated by combining the device ID, the instance ID of the data bus, and the device address of the interface. In one embodiment, the device address of the interface includes the hierarchical chain device address for the interface and the device address for the peripheral device.

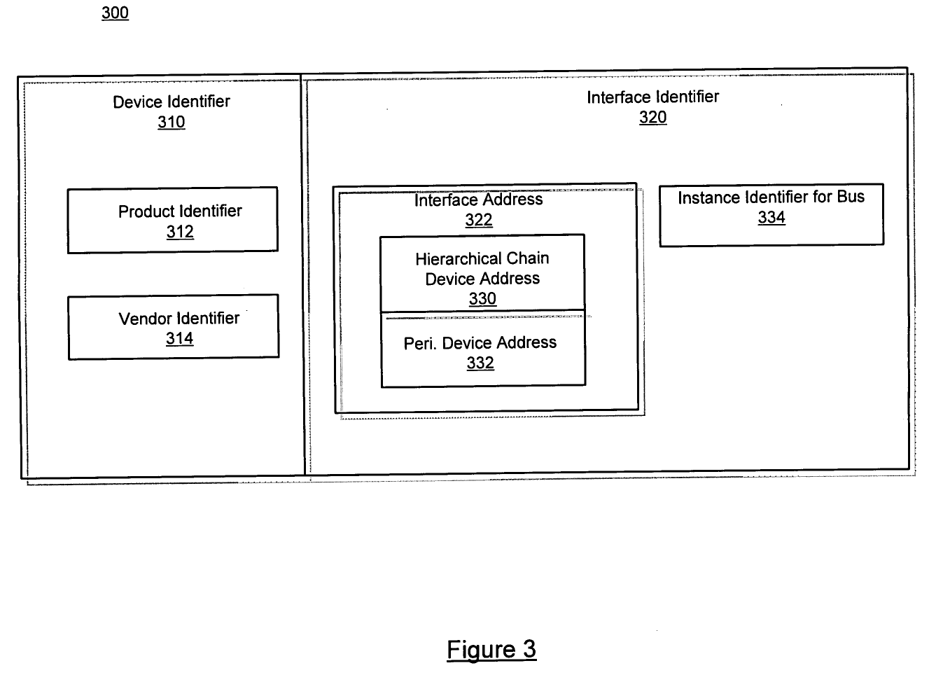

FIG. 3 is a block diagram showing an exemplary data structure including a persistent device identifier 300 according to an embodiment of the present technology. Persistent device identifier 300 includes devices identifier 310 identifying a peripheral device (e.g., peripheral device 250 of FIG. 2) communicatively coupled to a computer system at a interface (e.g., interface 210 of FIG. 2) and includes interface identifier for identifying the interface. It should be appreciated that device identifier 310 and interface identifier 320 are persistent across different instantiations of the peripheral device and the computer system.

In one embodiment, device identifier 310 is a vendor-defined identification string. In one embodiment, device identifier 310 includes a product identifier 312 uniquely identifying a product associated with the peripheral device and a vendor identifier 314 uniquely identifying a vendor of the peripheral device. An exemplary identification string for device identifier 310 is in the form of [vendor identifier]&[product identifier]. For instance, an example identification string is “VID_{—}054C&PID_{—}00BE”.

In one embodiment, interface identifier 320 includes interface address 322 and bus instance identifier 334. In one embodiment, bus instance identifier 334 is computer system-defined. In one embodiment, interface address 322 includes the hierarchical chain device address 330 for the interface between the data bus and the peripheral device. In one embodiment, the interface address also includes the peripheral device address 332.

For example, consider the following sub tree in a device configuration manager.

```
      Bus (Instance ID - [ACPI\PNP0A03\2&DABA3FF&0])
      ...
      ......
      USB Universal Host Controller - 24D2 (Address - 1900544)
        | USB Root Hub (Address - 0)
        | Generic USB Hub (Address - 1)
          | USB Composite Device (Device ID -
          USB\VID_054C&PID_00BE, Address - 1)
Bus instance identifier 334 for the above sub tree is
ACPI\PNP0A03\2&DABA3FF&0. One exemplary hierarchical chain
device address 330 for the above sub tree is 1900544\0\1.
Another exemplary hierarchical chain device address 330 including the
peripheral device address 332 for the above sub tree is 1900544\0\1\1.
```

In the present example, the peripheral device is a USB composite device downstream of a USB hub. The downstream hub is in turn connected to the USB controller.

In one embodiment, continuing with the present example, the persistent device identifier is:

### USB\VID_{—}054C&PI D_{—}00BE@[ACPI\PNP0A03\2&DABA3FF&0]\1900544\0\1\1

The persistent device identifier 300 includes the following information:
USB\VID_{—}054C&PID_{—}00BE—the device identifier of the peripheral device;
[ACPI\PNP0A03\2&DABA3FF&0]—the instance identifier of the data bus;
1900544—the address of the USB controller;
0—the address of the Root Hub;
1—the address of the downstream hub; and
1—the address of the peripheral device itself.

Moreover, it should be appreciated that the persistent device identifier is syntactic, and that the above persistent device identifier is exemplary. The persistent device identifier can include the above information in any order and/or format. For instance, other possible formats for the same device include:

USB\VID_054C&PID_00BE@ACPI\PNP0A03\2&DABA3FF&0\
1900544\0\1\1
USB\VID_054C&PID_00BE\hat{ }ACPI\PNP0A03\2&DABA3FF&0\
1900544\0\1\1
ACPI\PNP0A03\2&DABA3FF&0\USB\VID_054C&PID_00BE\
1900544\0\1\1

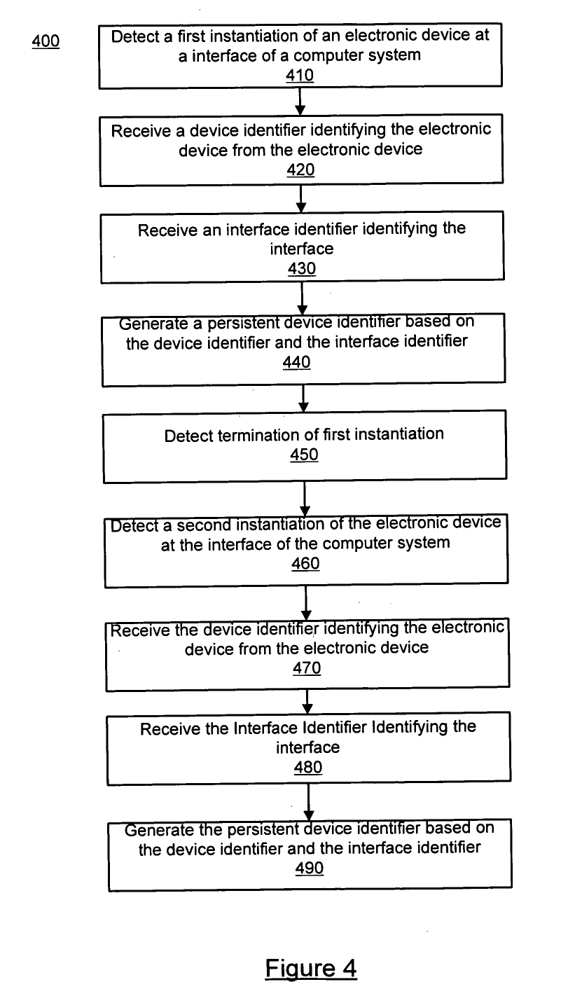

FIG. 4 is a flowchart 400 of one embodiment of a method for addressing an electronic device. Although specific steps are disclosed in flowchart 400, such steps are exemplary. That is, embodiments are well-suited to performing various other steps or variations of the steps recited in flowchart 400. It is appreciated that the steps in flowchart 400 may be performed in an order different than presented, and that not all of the steps in flowchart 400 may be performed. All of, or a portion of, the methods described by flowchart 400 may be implemented using computer-readable and computer-executable instructions which reside, for example, in computer-usable media of a computer system.

In one embodiment, at step 410, a first instantiation of an electronic device at a interface of a computer system is detected. At step 420, a device identifier is received from the electronic device communicatively coupled to the computer system at the interface. The device identifier identifies the electronic device. In one embodiment, the device identifier is received in response to a request for the device identifier. At step 430, an interface identifier identifying the interface is received. In one embodiment, the interface identifier is received in response to a request for the interface identifier.

At step 440, a persistent device identifier for the peripheral device is generated. In one embodiment, the persistent device identifier is generated responsive to detecting the first instantiation. The persistent device identifier is generated based on the device identifier and the interface identifier. Furthermore, the persistent device identifier includes persistent information that is static across different instantiations of the peripheral device and the computer system.

At step 450, termination of the first instantiation is detected. It should be appreciated that step 450 is optional, and that the termination of the first instantiation need not be actively detected. Rather, step 450 is indicative that at some point, the first instantiation terminates.

In one embodiment, at step 460, a second instantiation of the electronic device at the interface of a computer system is detected. At step 470, the device identifier is received from the electronic device communicatively coupled to the computer system at the interface. In one embodiment, the device identifier is received in response to a request for the device identifier. At step 480, the interface identifier is received. In one embodiment, the interface identifier is received in response to a request for the interface identifier.

At step 490, the persistent device identifier for the peripheral device is generated. In one embodiment, the persistent device identifier is generated responsive to detecting the second instantiation. The persistent device identifier is generated based on the device identifier and the interface identifier. In particular, it should be appreciated that the persistent device identifier generated at step 490 is identical to the persistent device identifier generated at step 440. Moreover, it should be appreciated that the persistent device identifiers generated for any number of instantiations of the peripheral device communicatively coupled to the interface are all identical.

As described herein, the generation of a persistent device identifier for a peripheral device across different instantiations of the peripheral device at an interface of a computing device is provided. For instance, this persistent device identifier provides static recognition of peripheral device across different plug and play and power management tests. The described embodiments allow for statically defining and describing test cases on peripheral devices by providing an invariable handle to the concerned peripheral device. The ability to statically define test cases by using the persistent device identifier allows for streamlining of testing, extracting parallelism and automating otherwise difficult to automate device and driver tests.

Embodiments of the present technology are thus described. While the present technology has been described in particular embodiments, it should be appreciated that the present technology should not be construed as limited by such embodiments, but rather construed according to the following claims.

What is claimed is:

1. A method for addressing an electronic device said method comprising:
receiving a device identifier from an electronic device communicatively coupled to a computer system at a interface, said device identifier identifying said electronic device;
receiving an interface identifier identifying said interface; and
generating a persistent device identifier based on said device identifier and said interface identifier, said persistent device identifier statically defining said electronic device at said interface across different instantiations of said electronic device at said computer system.

2. The method as recited in claim 1 wherein said device identifier comprises a vendor-defined identification string.

3. The method as recited in claim 1 wherein said device identifier comprises a vendor identifier unique to a vendor and a product identifier unique to a product.

4. The method as recited in claim 1 wherein said interface identifier comprises a device address of said interface and an instance identifier for a bus communicatively coupled to said interface.

5. The method as recited in claim 4 wherein said instance identifier comprises a computer system-defined identification string.

6. The method as recited in claim 4 wherein said interface identifier further comprises a device address of said electronic device.

7. The method as recited in claim 4 wherein said device address of said interface comprises a hierarchical chain device address between said bus and said electronic device.

8. A computer-readable medium having computer-executable instruction for performing steps comprising:
responsive to detecting a first instantiation of a peripheral device at a interface of a computer system, generating a persistent device identifier for said peripheral device, said persistent device identifier based on a device identifier and an interface identifier, said device identifier identifying said device and received from said peripheral device and said interface identifier identifying said interface; and
responsive to detecting a second instantiation of said peripheral device at said interface of said computer system, generating said persistent device identifier for said peripheral device based on said device identifier and said interface identifier, such that said persistent device identifier is the same at said first instantiation and said second instantiation.

9. The computer-readable medium as recited in claim 8 wherein said device identifier comprises a vendor-defined identification string.

10. The computer-readable medium as recited in claim 8 wherein said device identifier comprises a vendor identifier unique to a vendor and a product identifier unique to a product.

11. The computer-readable medium as recited in claim 8 wherein said interface identifier comprises a device address of said interface and an instance identifier for a bus communicatively coupled to said interface.

12. The computer-readable medium as recited in claim 11 wherein said instance identifier comprises a computer system-defined identification string.

13. The computer-readable medium as recited in claim 11 wherein said interface identifier further comprises a device address of said peripheral device.

14. The computer-readable medium as recited in claim 11 wherein said device address of said interface comprises a hierarchical chain device address between said bus and said peripheral device.

15. A computer-readable medium having stored thereon a data structure, comprising:
a first data field comprising data representing a persistent device identifier for statically defining an electronic device communicatively coupled to a computer system at a interface across different instantiations of said electronic device at said interface, said first data field comprising:
a second data field identifying said electronic device and received from said electronic device; and
a third data field identifying said interface.

16. The computer-readable medium as recited in claim 15 wherein said second data field comprises a vendor identifier data field unique to a vendor and a product identifier data field unique to a product.

17. The computer-readable medium as recited in claim 15 wherein said third data field comprises a first device address data field of said interface and an instance identifier field for a bus communicatively coupled to said interface.

18. The computer-readable medium as recited in claim 17 wherein said third data field further field comprises a second device address data field of said electronic device.

19. The computer-readable medium as recited in claim 17 wherein said first device address data field of said interface comprises a hierarchical chain device address data field comprising addresses between said bus and said electronic device.

20. The computer-readable medium as recited in claim 15 wherein said first data field is generated responsive to detecting an instantiation of said electronic device at said interface.
